(19) United States
(12) Patent Application Publication
(10) Pub. No.: US 2007/0136601 A1
(43) Pub. Date: Jun. 14, 2007

(54) Authentication system and method in DSTM communication network

(76) Inventors: Take-Jung Kwon, Seoul (KR); Young-Han Kim, Seoul (KR); Sou-Hwan Jung, Seoul (KR); Jae-Duck Choi, Hwaseong-si (KR); Sun-Gi Kim, Seoul (KR)

Correspondence Address: Robert E. Bushnell, Suite 300, 1522 K Street, N.W., Washington, DC, 20005, US

(21) Appl. No.: 11/598,139

(22) Filed: Nov. 13, 2006

(30) Foreign Application Priority Data
Dec. 12, 2005 (KR) 10-2005-0122161

(51) Int. Cl. H04L 9/00

(52) U.S. Cl. 713/182

(57) ABSTRACT

Provided are a system and method for allocating an Internet protocol version 4 (IPv4) address through authentication of a dual stack transition mechanism (DSTM) node in a DSTM communication network, DSTM being an IPv4/IPv6 address translation mechanism. The system and method perform authentication when an IPv4 address is allocated between a DSTM node and the DSTM server in the DSTM communication network. According to the system and method, when the DSTM node requests IPv4 address allocation, the DSTM server authenticates the DSTM node, and then allocates an IPv4 address. Therefore, it is possible to solve a problem of exhaustion of an IPv4 address pool of the DSTM server by a denial of service (DoS) attack, as well as potentially solve a security problem of an IPv4/IPv6 translation process.

### CLAIM OF PRIORITY

This application makes reference to, incorporates the same herein, and claims all benefits accruing under 35 U.S.C.§119 from an application for AUTHENTICATION SYSTEM IN DSTM COMMUNICATION NETWORK AND METHOD USING THE SAME earlier filed in the Korean Intellectual Property Office on 12 Dec. 2005 and there duly assigned Serial No. 10-2005-0122161.

### BACKGROUND OF THE INVENTION

1. Field of the Invention

The present invention relates to Internet Protocol (IP) version 4 (IPv4) and IP version 6 (IPv6) address translation technology, and more particularly, to a system and method for authenticating a dual stack transition mechanism (DSTM) node when an IPv4 address is allocated between the DSTM node and a DSTM server in a DSTM communication network.

2. Description of the Related Art

Currently, a network protocol that is widely accepted and used on the basis of the Internet is Internet Protocol (IP). IP protocol has been developed through several design modifications, and currently, IPv4 is widely used throughout the Internet. IPv4 is designed to be relatively simple and flexible, but has drawbacks such as lack of available IP addresses, inefficiency of IP packet routing, complexity of various configuration processes that are required to drive an IP node, etc.

In order to improve upon such weak points, IPv6, also known as Internetworking Protocol next generation (IPng), was suggested and has become the current standard. As a result, the number of network devices has increased lately, and thus IPv6 networks are undergoing considerable extension. However, most network devices are still used in conventional IPv4 networks. Therefore, interoperation is needed between IPv6 networks and IPv4 networks, and thus mutual translation of IP addresses is required. More specifically, an address translator that translates an IPv6 address into an IPv4 address and vice versa is required so that nodes connected to the IPv6 network and nodes connected to the IPv4 network can interoperate and communicate with each other.

Currently, Internet Engineering Task Force (IETF) is standardizing various translation techniques, among which, DSTM (Dual Stack Transition Mechanism) and Network Address Translation-Protocol Translation (NAT-PT) schemes are on the rise. The present invention is directed to the DSTM translation technique.

According to the DSTM, terminals located in the IPv6 network have two protocol stacks of IPv4 and IPv6. In order to enable communication, the IPv6 stack is used when one of the terminals is connected to an IPv6 node, and the IPv4 stack is used in an IPv4-in-IPv6 tunneling mechanism when the terminal is connected to an IPv4 node. The DSTM comprises a DSTM server, a Tunnel End Point (TEP), and a DSTM node (IPv6 node). When the DSTM node intends to connect to an IPv4 node in the IPv4 network, it is allocated the IPv6 address of a TEP where a tunnel is to be set up and a global IPv4 address for temporary use from the DSTM server. Currently, use of a dynamic host configuration protocol version 6 (DHCPv6) server as the DSTM server is being discussed in an IETF v6ops working group.

In a conventional process, a DSTM node obtains an IPv4 address for communication with an IPv4 node, and a problem in which an IPv4 address pool of a DSTM server is exhausted by a DSTM node attacker.

A DSTM node that wants to communicate with an IPv4 host in an IPv4 network sends an address-allocation request message to a DSTM server to obtain an IPv4 address. The DSTM server receiving the address-allocation request message selects an address in its own IPv4 pool and responds to the DSTM node. In this process, the DSTM server does not provide any authentication method for coping with the IPv4-address allocation request. Here, when an address is allocated without any authentication process, if the DSTM node is a DSTM attacker, the DSTM node spoofs an IPv6 source address and sends the IPv4-address-allocation request message to the DSTM server.

The DSTM server sends an IPv4-address-allocation response message to the DSTM node in response to the IPv4-address-allocation request message. The DSTM server allocates an IPv4 address for the corresponding IPv6 address, records the corresponding information in its own IPv4 address mapping table, and sends the corresponding mapping information to a TEP which is a boundary router of a DSTM domain. The TEP stores the received mapping information in a mapping table. Here, a node that receives the IPv4-address-allocation-request response message actually does not exist or did not generate the allocation request message. Continuously changing the IPv6 source address, the attacker repeats the process described above, and thereby can use up IPv4 addresses of the DSTM server.

In order to solve this problem, the V6ops working group belonging to the ETF uses a DHCP (or DHCPv6) server as a DSTM server, and thus uses a dynamic host configuration protocol (DHCP) authentication method for a DSTM server to authenticate a node. The DHCPv6 authentication method is the same as the DHCP authentication method.

Authentication methods used for DHCP can be roughly classified into three kinds. The first kind uses the media access control (MAC) address of a node for authentication. According to the MAC authentication method, a terminal to use a DHCP service in a DHCP communication network registers its own MAC address with a DHCP server. The registration process is performed by an administrator of the DHCP communication network. The registered MAC address is used for an authentication value when the DHCP terminal sends an IPv4-address-allocation request message. The second kind of DHCP authentication method is a delayed authentication method. According to the delayed authentication method, when a DHCP server sends a message to a DHCP node in response to an IPv4-address-allocation request message, a DHCP terminal generates an authentication value according to a hash algorithm using a password shared between the DHCP terminal and server and a value included in the message. The third kind of DHCP authentication method uses a certificate for authentication.

The conventional methods mentioned above can be used to solve the problem of IPv4-address pool exhaustion. However, when communication is desired in a mobile environment in which terminals are mobile, or in another communication network, the authentication methods require an additional process of sharing secret information with a DHCP server, and thus are very inefficient to apply to a communication network.

Therefore, a new authentication method is required to solve a problem that may occur when a conventional technique is used in IPv6/IPv4 transition technology essential to IPv6 infrastructure.

### SUMMARY OF THE INVENTION

It is an objective of the present invention to provide a system and method for authenticating a DSTM node in a DSTM communication network, the system and method capable of solving a problem of DSTM server IPv4 address pool exhaustion caused by a denial of service (DoS) attack in the DSTM communication network, and being applied to an actual communication network.

It is another objective of the present invention to provide a node authentication system and method in a network providing an IPv4 allocation service like a DHCP server and a DSTM server.

According to an aspect of the present invention, there is provided an authentication method in a DSTM communication network comprising the steps of storing, at a DSTM server, at least one image file to be used for authentication and at least one authentication value for the image file in a database; sending, at the DSTM server, the image file to a DSTM node requesting address allocation; when a user of the DSTM node inputs an authentication value that can be found through the received image file, sending, at the DSTM node, the input authentication value and image file to the DSTM server; and comparing, at the DSTM server, the authentication value and image file received from the DSTM node to the authentication value and image file stored in the database, and thereby performing authentication.

The authentication method may further comprise the step of allocating, at the DSTM server, an IP address to the DSTM node.

The image file may be expressed in text that can be recognized by people.

The authentication value may correspond to a blank in the text of the image file or a response to a specific question.

The database may further store a valid time value of the image file and a checksum of the image file.

The authentication method may further comprise the step of calculating, at the DSTM server, the checksum of the image file received from the DSTM node, and comparing the calculated checksum to the stored checksum.

According to another aspect of the present invention, there is provided an authentication system in a DSTM communication network including a DSTM server and DSTM node, comprising the DSTM server that stores an image file to be used for authentication and an authentication value expected through the image file in a database, sends the image file to the DSTM node, and performs authentication of the DSTM node using information received from the DSTM node; and the DSTM node that sends a value input by a user according to the image file received from the DSTM server and the image file to the DSTM server.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram showing a problem in which an Internet Protocol version 4 (IPv4)-address pool of a dual stack transition mechanism (DSTM) server is exhausted by a DSTM node (IPv6 node) attacker in a DSTM communication network;

FIG. 2 is a flowchart showing a human recognition authentication method applied between a DSTM node and DSTM server according to an exemplary embodiment of the present invention;

FIG. 3 is a table showing fields and field values of a challenge database included in a DSTM server according to an exemplary embodiment of the present invention;

FIG. 4 is a diagram showing a process of generating new challenge data to be sent from a DSTM server to a DSTM node according to an exemplary embodiment of the present invention;

FIG. 5 shows an authentication option message of dynamic host configuration protocol version 6 (DHCPv6), the message including examples of values of an authentication-information field and an algorithm field according to an exemplary embodiment of the present invention;

FIG. 6 shows an embodiment of user input at a DSTM node according to an exemplary embodiment of the present invention;

FIG. 7 is a flowchart showing a process performed for a DSTM server to allocate an IPv4 address to a DSTM node according to an exemplary embodiment of the present invention; and

FIG. 8 is a diagram showing an entire system performing the human recognition authentication method according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. Like elements are denoted by like reference numerals throughout the drawings. Matters related to the present invention and well-known in the art will not be described in detail when deemed that such description would detract from the clarity and concision of the disclosure. The present invention provides an authentication system and method performing authentication through a responding process according to an authentication message that can be recognized by people instead of an automated mechanism of the system in response to an authentication request, in order to authenticate a dual stack transition mechanism (DSTM) node.

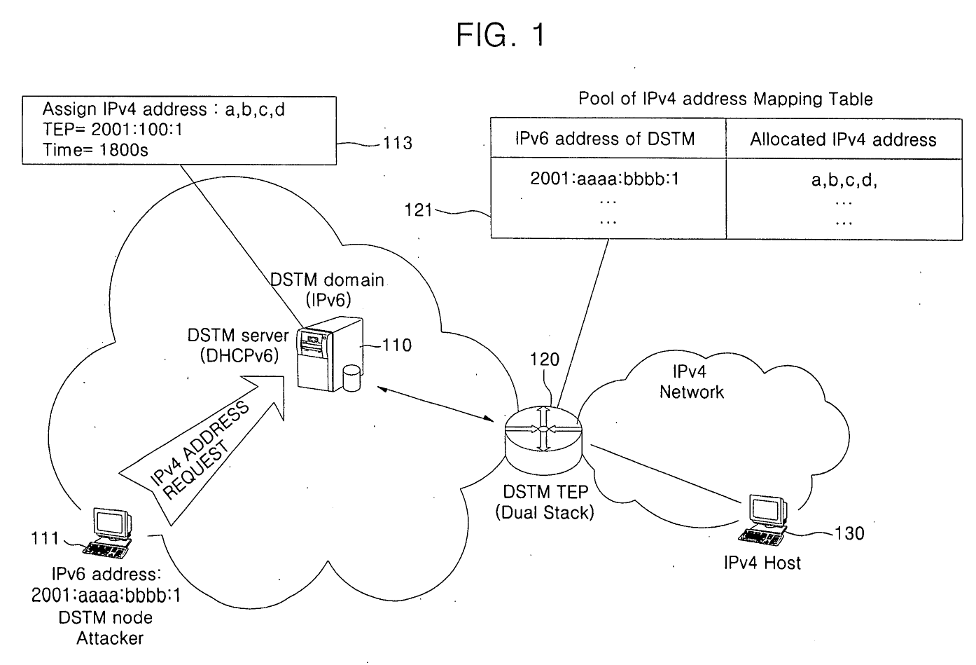

FIG. 1 illustrates a process in which a DSTM node obtains an IPv4 address for communication with an IPv4 node, and a problem in which an IPv4 address pool of a DSTM server is exhausted by a DSTM node attacker.

As illustrated in FIG. 1, a DSTM node 111 that wants to communicate with an IPv4 host 130 in an IPv4 network sends an address-allocation request message to a DSTM server 110 to obtain an IPv4 address. The DSTM server 110 receiving the address-allocation request message selects an address in its own IPv4 pool and responds to the DSTM node 111. In this process, the DSTM server 110 does not provide any authentication method for coping with the IPv4-address allocation request. Here, when an address is allocated without any authentication process, if the DSTM node 111 is a DSTM attacker, the DSTM node 111 spoofs an IPv6 source address and sends the IPv4-address-allocation request message to the DSTM server 110.

The DSTM server 110 sends an IPv4-address-allocation response message to the DSTM node 111 in response to the IPv4-address-allocation request message. The DSTM server 110 allocates an IPv4 address for the corresponding IPv6 address, records the corresponding information in its own IPv4 address mapping table 113, and sends the corresponding mapping information to a TEP 120 which is a boundary router of a DSTM domain. The TEP 120 stores the received mapping information in a mapping table 121. Here, a node that receives the IPv4-address-allocation-request response message actually does not exist or did not generate the allocation request message. Continuously changing the IPv6 source address, the attacker repeats the process described above, and thereby can use up IPv4 addresses of the DSTM server 110.

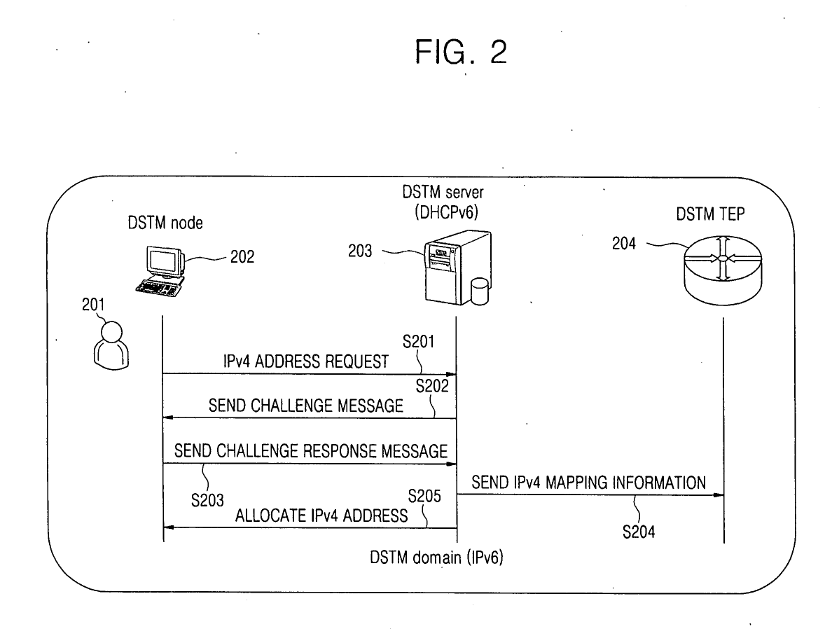

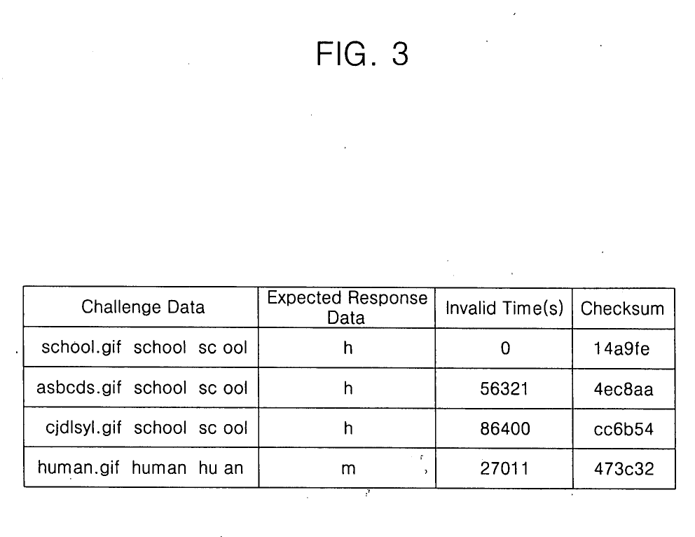

FIG. 2 is a flowchart showing a human-recognition authentication method applied between a DSTM node and a DSTM server according to an exemplary embodiment of the present invention, and FIG. 3 is a table showing fields and field values of a challenge database included in the DSTM server according to an exemplary embodiment of the present invention.

In the following detailed description of exemplary embodiments of the present invention, “challenge database” and “challenge data” denote a database and authentication message data used in the exemplary embodiments.

As illustrated in FIG. 2, a DSTM node 202 requests an Internet protocol version 4 (IPv4) address, required in order to communicate with a node in an IPv4 domain, from a DSTM server 203 (S201).

When the Internet protocol (IP) allocation request is received, the DSTM server 203 selects arbitrary challenge data from the challenge database, such as shown in FIG. 3, and then sends the challenge data to the DSTM node 202 (S202).

Subsequently, a user 201 inputs an authentication value appropriate for information included in the received challenge data, and then the DSTM node 202 sends a challenge-data response message to the DSTM server 203 (S203). The challenge-data response message includes an authentication value to be compared to the expected response data in the challenge database, and may include an image file received by the DSTM node 202 as the challenge data.

The DSTM server 203 receiving the challenge-data response message determines whether or not the received message matches the expected response data of the challenge database, and when a match occurs, sends IPv4 address mapping information to a DSTM tunnel end point (TEP) 204 (S204).

Subsequently, the DSTM server 203 allocates the IPv4 address to the DSTM node 202 (S205).

Data of the challenge database shown in FIG. 3 includes challenge data (image files), expected response data (authentication value), invalid times (valid time value), and checksum values of the challenge data.

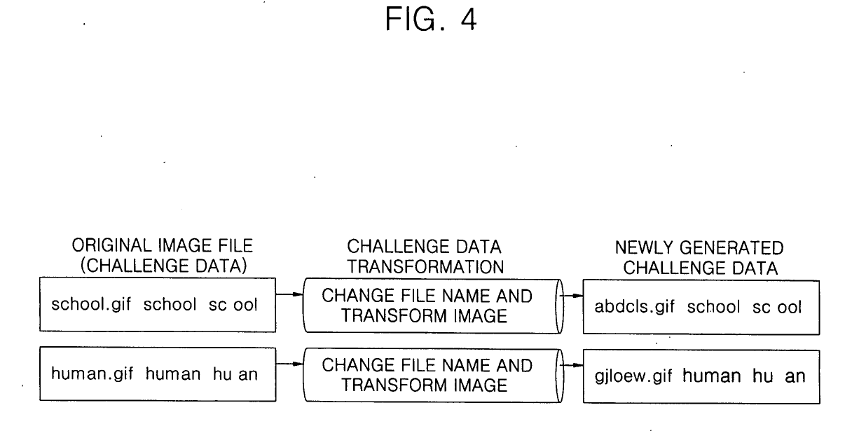

The challenge data is a value used when the DSTM server requests the DSTM node for an input for authentication, and must be an image file showing a text expression that can be recognized by people. The expected response data is information that is input to the DSTM node by the user, sent to the DSTM server, and used for an authentication value. The invalid time is a value used for preventing challenge data from being repeatedly used. When arbitrary challenge data is selected, the invalid time of the selected value is set to 86,400 seconds. And, when the DSTM node correctly responds to the challenge data and thus authentication is successful, the invalid time is reduced by 1 second to the minimum of 0 seconds. The 86,400 seconds is not a fixed value and can be changed by an administrator. In addition, when the challenge data is insufficient, additional challenge data can be generated by a method illustrated in FIG. 4.

When an invalid time value of challenge data to be used in response to the IPv4 allocation request of another DSTM node is not 0, the DSTM server should select other challenge data having an invalid time value of 0. Lastly, the checksum value of challenge data (image file) is calculated by the DSTM server after image transformation of the challenge data to be transmitted so that a malicious node cannot recognize a pattern of the challenge data received every time IPv4 allocation is requested by the DSTM node.

The image transformation is bit conversion of a file that is performed as far as people can recognize a text expression of an image. Consequently, even though an image file of a same expression is received, a malicious node cannot recognize a pattern through received data.

FIG. 4 is a diagram showing a process in which a DSTM server changes a file name and the checksum value of a file both corresponding to arbitrary challenge data in a challenge database, and generates unique challenge data.

As illustrated in FIG. 4, another file name for original challenge data is generated, bit conversion of a file is performed as far as a text expression that can be recognized by people is maintained, and then a checksum is calculated.

A DSTM server registers and stores newly generated challenge data in a database. After receiving a response according to challenge data from a DSTM node, the DSTM server calculates the checksum value of challenge data (image file) received from the DSTM node and can authenticate the DSTM node using an invalid time and expected response data obtained from the challenge database and the calculated checksum value.

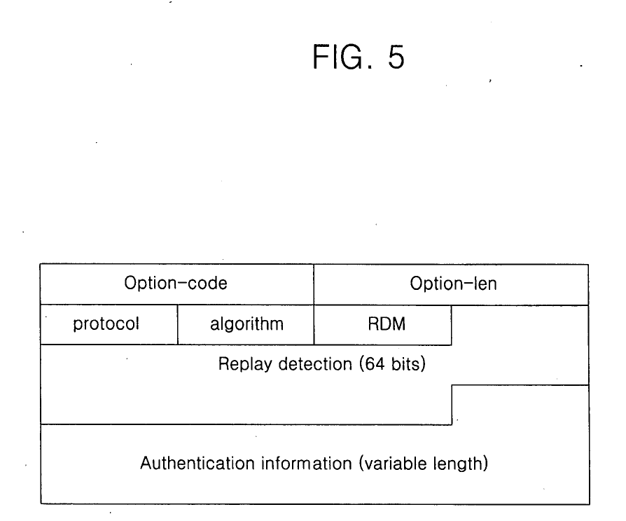

FIG. 5 shows an authentication option message in the form of dynamic host configuration protocol version 6 (DHCPv6) used when a challenge data message appearing in step S202 of FIG. 2 is transmitted. The present invention uses a DHCPv6 authentication option message of Request for Comments (RFC) 3315 as is, and thus only modified parts will be described in this specification.

As illustrated in FIG. 5, with a human recognition (HR) name that is suggested by the present invention included in an algorithm field, and the challenge data that is generated as described above included in an authentication-information field, authentication is requested to a DSTM node.

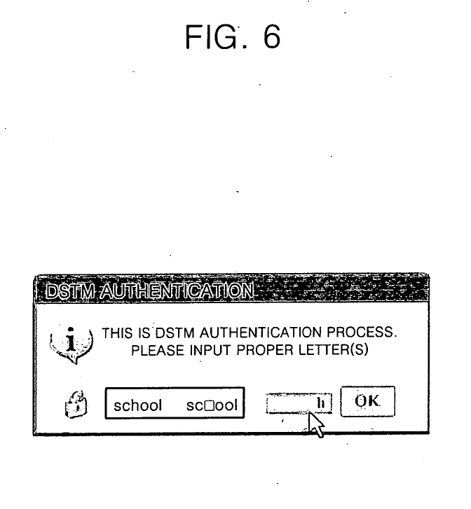

FIG. 6 shows an embodiment in which a user of a DSTM node manually inputs an input value in response to an input request of a DSTM server. Afterward, the DSTM node sends the input value input by the user and challenge data (image file) received from the DSTM server to the DSTM server. The DSTM server receives the response to the input request from the DSTM node. The DSTM server checks whether or not a response expression in the response message received from the user of the DSTM node is the same as a value in a challenge database of the DSTM server. The DSTM server sends an IPv4-allocation rejection message when the same value is not in the challenge database, and allocates an IPv4 address to the DSTM node when the same value is in the challenge database.

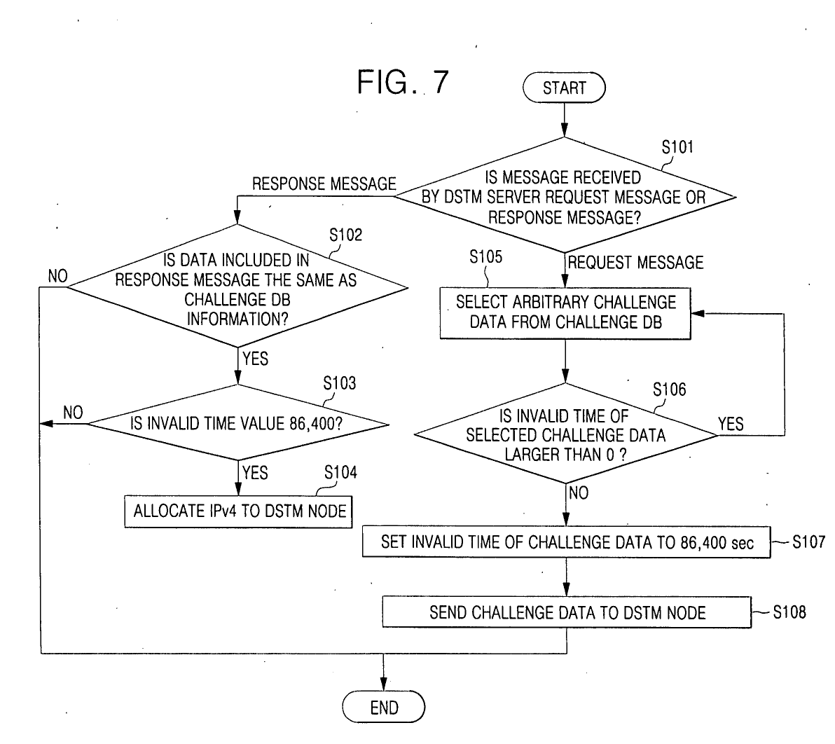

FIG. 7 is a flowchart showing a process performed by a DSTM server in response to an IPv4-address allocation request of a DSTM node. The DSTM server determines whether a message received from the DSTM node is an IPv4-allocation request message or a response message (S101). When the message is determined to be an IPv4-allocation request message, the DSTM server checks the invalid values of challenge data in a challenge database, and then selects challenge data having an invalid time value of 0 (S105, S106). The invalid time value of the selected challenge data is set to 86,400 seconds, and stored in the challenge database of the DSTM server (S107). The invalid time value is randomly set up by an administrator, and can be changed according to system environment or other conditions. After storing the invalid time value, the DSTM server sends generated challenge data to the DSTM node (S108).

On the contrary, when the received message is determined to be a response message, the DSTM server calculates expected response data and the checksum of a file, and then checks whether or not the same value is in the challenge database thereof (S102). After the DSTM server checks whether or not the same value is in the challenge database, it is checked that the invalid time value of the same challenge data is 86,400 (S103). When the invalid time value of the same challenge data is 86,400, an IPv4 address is allocated and the invalid time value is reduced by 1 second to the minimum of 0 seconds (S104). When the invalid time value is less than 86,400, an IPv4 address is not allocated because a repeated authentication response message is received. Processes performed after authentication of the DSTM node is confirmed are the same as in conventional methods.

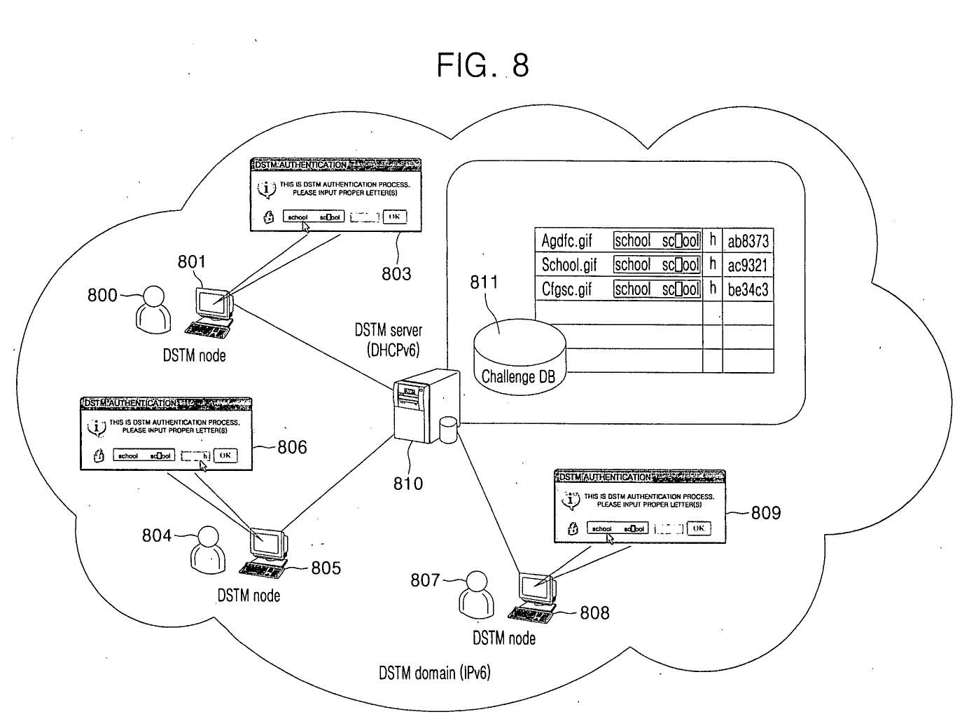

FIG. 8 is a diagram of a system employing the present invention, showing an example in which users 800, 804 and 807 of DSTM nodes 801, 805 and 808 input authentication values according to an image of challenge data transmitted from a DSTM server 810 in order to be allocated IPv4 addresses. A challenge database 811 stores the challenge data transmitted to each DSTM node 801, 805 and 808. The users 800, 804 and 807 look at the image of the challenge data, and input the authentication values. In the case described above, when “h” is input for the value of a blank in “sc□ool”, which is an image of the word “school,” authentication for IPv4 address allocation is performed. The image is made for filling in blanks, but also can be made for a question and answer.

As described above, the system and method for authenticating a DSTM node according to an exemplary embodiment of the present invention does not require information that is shared in advance such as the media access control (MAC) address of a terminal, a password, and a certificate. Also, when the terminal moves to another domain, according to conventional authentication methods, an on-line or off-line process is required to obtain new information that can be shared between the terminal and server. But, the system according to an exemplary embodiment of the present invention can be allocated an IP address through real-time authentication in the new domain anywhere, anytime, without any additional process.

In addition, automatic response of a system is impossible, and thus the present invention can efficiently cope with an IP exhaustion problem due to a denial of service (DoS) attack, and so forth. Since only users (people) can respond to the request of a DSTM server, it is impossible to respond to the authentication request of the server using an automated mechanism of the system, and thus the present invention can efficiently cope with the IP exhaustion problem.

In addition, using the new authentication mechanism in consideration of a DSTM environment, which is IPv4/IPv6 translation technology, a solution for an IP-address allocation problem can be suggested.

While the present invention has been described with reference to exemplary embodiments thereof, it will be understood by those skilled in the art that various changes in form and detail may be made therein without departing from the scope of the present invention as defined by the following claims.

What is claimed is:

1. An authentication method in a dual stack transition mechanism (DSTM) communication network, comprising the steps of:
storing, at a DSTM server, at least one image file to be used for authentication and at least one authentication value corresponding to the image file in a database;
sending the image file to a DSTM node requesting an address allocation from the DSTM server;
sending an authentication value, input by a user in response to the image file, to the DSTM server from the DSTM node; and
comparing, at the DSTM server, the authentication value received from the DSTM node to the authentication value stored in the database, and thereby performing authentication.

2. The authentication method according to claim 1, further comprising the step of:
allocating, at the DSTM server, an Internet protocol (IP) address to the DSTM node upon authentication.

3. The authentication method according to claim 1, wherein the image file corresponds to text that can be recognized by the user.

4. The authentication method according to claim 3, wherein the authentication value corresponds to a blank in the text of the image file.

5. The authentication method according to claim 3, wherein the authentication value corresponds to a response to a specific question.

6. The authentication method according to claim 1, wherein the database further stores a valid time value and a checksum of the image file.

7. The authentication method according to claim 6, further comprising the step of:
calculating, at the DSTM server, a checksum of the image file received from the DSTM node, and comparing the calculated checksum to the stored checksum.

8. An authentication system in a dual stack transition mechanism (DSTM) communication network including a DSTM server and a DSTM node, comprising:
the DSTM server storing, in a database, an image file to be used for authentication and an expected authentication value corresponding to the image file, said DSTM server sending the image file to the DSTM node in response to an address allocation request message from the DSTM node, and then performing authentication of the DSTM node using user input authentication information received from the DSTM node in response to a display of an image corresponding to the image file received from the DSTM server; and
the DSTM node sending an authentication value corresponding to the input authentication information to the DSTM server.

9. The authentication system according to claim 8, wherein the DSTM node sends the image file to the DSTM server with the authentication value.

10. The authentication system according to claim 8, wherein the DSTM server performs authentication of the DSTM node, and then allocates an Internet Protocol (IP) address to the DSTM node.

11. The authentication system according to claim 8, wherein the image file corresponds to text that can be recognized by people.

12. The authentication system according to claim 10, wherein the authentication value corresponds to a blank in the text of the image file or a response to a specific question.

13. The authentication system according to claim 8, wherein the database further stores a valid time value of the image file and a checksum of the image file.

14. The authentication system according to claim 12, wherein the DSTM server calculates a checksum of the image file received from the DSTM node and compares the calculated checksum to the stored checksum.

15. The authentication system according to claim 10, wherein the DSTM node is located in an Internet protocol version 6 (IPv6) address domain and the allocated Internet Protocol (IP) address is an Internet protocol version 4 (IPv4) address.

16. An authentication method in a dual stack transition mechanism (DSTM) communication network, comprising the steps of:
storing, at a DSTM server, at least one image file to be used for authentication and at least one authentication value corresponding to the image file in a database;
sending the image file to a DSTM node located in an Internet protocol version 6 (IPv6) address domain requesting an Internet protocol version 4 (IPv4) address allocation from the DSTM server;
sending an authentication value, input by a user in response to the image file, to the DSTM server from the DSTM node; and
comparing, at the DSTM server, the authentication value received from the DSTM node to the authentication value stored in the database, and thereby performing authentication.

17. The authentication method according to claim 16, further comprising sending the image file to the DSTM server with the authentication value.
